(19) United States
(12) Patent Application Publication
(10) Pub. No.: US 2010/0011927 A1
(43) Pub. Date: Jan. 21, 2010

(54) Apparatus for cutting flat display panel

(76) Inventors: Jae-Pil Lee, Yongin-City (KR); Ki-Chul Kim, Yongin-City (KR)

Correspondence Address: ROBERT E. BUSHNELL & LAW FIRM, 2029 K STREET NW, SUITE 600, WASHINGTON, DC, 20006-1004, US

(21) Appl. No.: 12/458,553

(22) Filed: Jul. 15, 2009

(30) Foreign Application Priority Data
Jul. 16, 2008 (KR) 10-2008-0069172

(51) Int. Cl. B26D 7/18

(52) U.S. Cl. 83/100; 83/78

(57) ABSTRACT

An apparatus for cutting a flat display panel to prevent a light emitting surface of the flat display panel from becoming defective and contaminated while cutting the flat display panel is disclosed. The apparatus for cutting a flat display panel includes a stage to support a rear substrate of a flat display panel, a scribing support block to support a front substrate the flat display panel, a cutter to scribe the rear substrate of the flat display panel, and a scrap breaker to grip a scrap portion of the flat display panel that is to be separated from the flat display panel after cutting process of the flat display panel.

### CLAIM OF PRIORITY

This application makes reference to, incorporates the same herein, and claims all benefits accruing under 35 U.S.C. §119 from an application for APPARATUS FOR CUTTING FLAT DISPLAY PANEL earlier filed in the Korean Intellectual Property Office on the 16 Jul. 2008 and there duly assigned Serial No. 10-2008-0069172.

### BACKGROUND OF THE INVENTION

1. Field of the Invention

The present invention relates to an apparatus for cutting a flat display panel and, more particularly, to an apparatus for cutting a flat display panel that is capable of preventing a light emitting surface of the flat display panel from becoming defective and contaminated while cutting the flat display panel.

2. Description of the Related Art

Flat display panels include a liquid crystal display (LCD), a plasma display panel (PDP), and an organic light emitting diode (OLED) display. For convenience sake, the OLED display will be described as an example of the flat display panel.

The OLED display includes organic light emitting diodes including hole injection electrodes, an organic light emission layer, and electron injection electrodes, in which light is emitted by energy generated when excitons, generated as electrons and holes are combined, drop from an excited state to a ground state.

The OLED display includes subpixels disposed in a matrix form at a display area. Each subpixel includes an organic-light emitting element and a driving circuit unit. The driving circuit unit includes a switching transistor, a driving transistor, and a storage capacitor.

The OLED display is formed by forming subpixels on a rear substrate, and sealing the rear substrate and a front substrate together. A cutting apparatus is used to cut the rear substrate and the front substrate, that is, glass substrates, of the OLED display.

For example, an OLED display is put on a stage of the cutting apparatus, scratches are made on an upper surface of the glass substrates, and cracking is performed along the scratches to thereby cut the glass substrates.

The stage of the cutting apparatus may cause scratches on the glass substrates mounted thereon, so if a surface contacting the stage is a light emitting surface of the OLED display, the light emitting surface may become defective or contaminated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus for cutting a flat display panel having advantages of preventing a light emitting surface of the flat display panel from becoming defective and contaminated when performing a cutting operation.

The present invention has been also made in an effort to provide an apparatus for cutting a flat display panel having advantages of removing factors that may cause deficiency in association with a process after a cutting operation.

An exemplary embodiment of the present invention provides an apparatus for cutting a flat display panel including a stage to support a rear substrate the flat display panel, a scribing support block disposed over the flat display panel and supporting the flat display panel while the flat display panel is being cut, a cutter to scribe the flat display panel, and a scrap breaker to grip a scrap portion of the flat display panel that is to be separated from the flat display panel after cutting the flat display panel.

The scribing support block may be disposed to be aligned to one edge of a front substrate of the flat display panel to support the front substrate. The scribing support block may have a length that is substantially the same as a length of the one edge of the front substrate of the flat display panel.

The scribing support block may be connected to a first driving member that is disposed substantially perpendicular to the stage, the first driving member moving the scribing support block in a direction perpendicular to the front substrate.

The cutter may include a wheel. The cutter may scribe the rear substrate of the flat display panel in a direction along an edge of the scribing support block. The wheel may be connected to a second driving member that moves the wheel in a direction perpendicular to the rear substrate.

The scrap breaker may include a cup to vacuum-grip the scrap portion of the flat display panel, a delivery member holding the cup and applying a vacuum to the cup, and a third driving member connected with the delivery member to move the delivery member and the cup in a direction perpendicular to the rear substrate.

The flat display panel may be formed as an OLED display. The front substrate of the flat display panel may include a light emitting surface of the flat display panel.

Another embodiment of the present invention provides an apparatus for cutting a flat display panel, including a stage to support a rear substrate of an organic light emitting diode (OLED) display, a scribing support block to support a front substrate of the OLED display, a cutter to scribe the rear substrate of the OLED display, and a scrap breaker to grip a scrap portion of the OLED display that is to be separated from the rear substrate after cutting the OLED display.

The scribing support block may be disposed to be aligned to one edge of a front substrate, and the scribing support block may have a length that is substantially the same as a length of the one edge of the front substrate of the OLED display.

In the exemplary embodiment of the present invention, the non-light emitting surface of the flat display panel is supported by the stage, the light emitting surface is supported by the scribing support block, and the flat display panel is scribed with a cutter at the side of the non-light emitting surface, so the light emitting surface can be prevented from becoming defective and contaminated. In the exemplary embodiment of the present invention, because the light emitting surface of the flat display panel can be prevented from becoming defective and contaminated, factors that may cause deficiency in association with a follow-up process of the cutting operation can be eliminated.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view of an apparatus for cutting a flat display panel according to an exemplary embodiment of the present invention.

FIG. 2 is a front view of the flat display panel cutting apparatus in FIG. 1.

FIG. 3 is a schematic diagram illustrating the structure of a sub-pixel circuit of the flat display panel in FIG. 1.

FIG. 4 is a partially enlarged sectional view of the flat display panel in FIG. 1.

FIG. 5 is a top plan view of the flat display panel in FIG. 1 before it is scribed.

FIG. 6 is a side view showing the flat display panel in FIG. 1 in a scribed state.

FIG. 7 is a top plan view of the flat display panel in FIG. 1 in a cut state.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

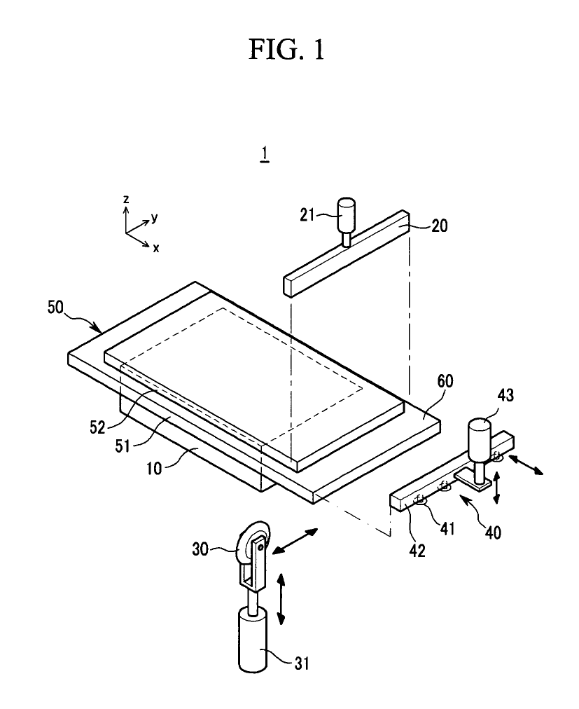

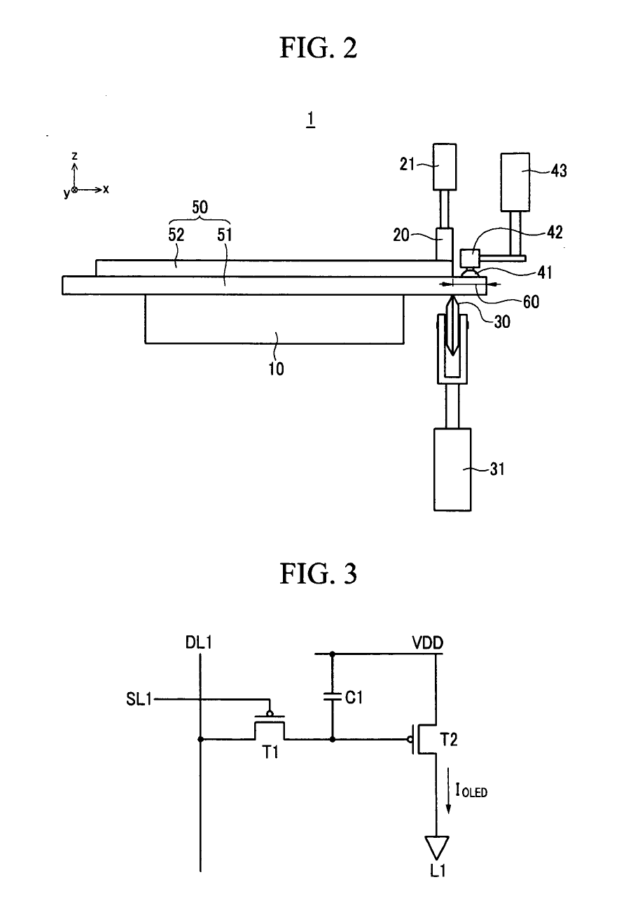

FIG. 1 is an exploded perspective view of an apparatus for cutting a flat display panel according to an exemplary embodiment of the present invention, and FIG. 2 is a front view of the flat display panel cutting apparatus in FIG. 1.

With reference to FIGS. 1 and 2, a flat display panel cutting apparatus 1 includes a stage 10, a scribing support block 20, a cutter 30, and a scrap breaker 40.

The stage 10 has an upper surface as a horizontal plane to support a flat display panel 50. The flat display panel 50 is formed by sealing a rear substrate 51 including a non-light emitting surface and a front substrate 52 including a light emitting surface.

The flat display panel 50 may be a liquid crystal display (LCD), a plasma display panel (PDP), or an organic light emitting diode (OLED) display. For convenience sake, the OLED display will be taken as an example to be described in this exemplary embodiment of the present invention.

In the present exemplary embodiment, the flat display panel 50, that is, the rear substrate 51 of the OLED display, is cut such that it corresponds to the front substrate 52. First, before a description is given of the cutting operation, the configuration of the OLED will be described. In the OLED display, subpixels are formed in a matrix form (two dimensional array) on the display area of the rear substrate 51 and the front substrate 52.

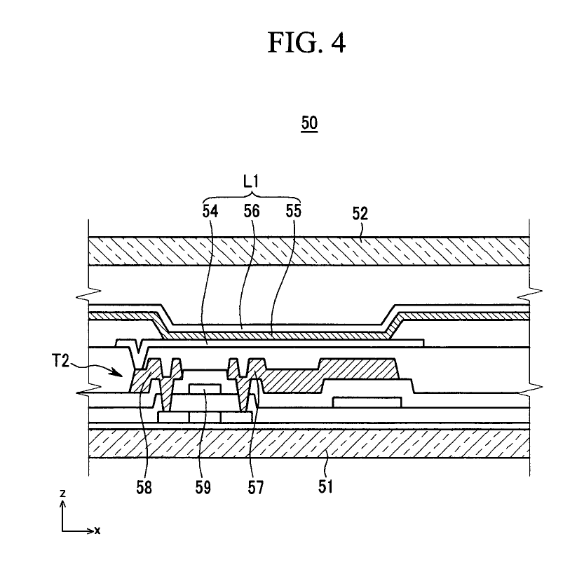

FIG. 3 is a schematic diagram illustrating the structure of a sub-pixel circuit of the flat display panel in FIG. 1, and FIG. 4 is a partially enlarged sectional view of the flat display panel in FIG. 1. With reference to FIGS. 3 and 4, each subpixel of the OLED display includes an organic light emitting element L1 and a driving circuit unit. The organic light emitting element L1 includes an anode electrode 54, an organic light emission layer 55, and a cathode electrode 56.

The driving circuit unit includes at least two thin film transistors (TFTs) and at least one storage capacitor C1. The TFTs basically include a switching transistor T1 and a driving transistor T2.

The switching transistor T1 is connected to a scan line SL1 and a data line DL1, and transmits a data voltage inputted from the data line DL1 to the driving transistor T2 according to a switching voltage inputted to the scan line SL1.

The storage capacitor C1 is connected to the switching transistor T1 and a power line VDD and stores a voltage corresponding to a difference between a voltage transmitted from the switching transistor T1 and a voltage supplied from the power line VDD.

The driving transistor T2 is connected to the power line VDD and the storage capacitor C1, and supplies an output current I_{OLED}, which is proportional to the square of a difference between a voltage stored in the storage capacitor C1 and a threshold voltage, to the organic light emitting element L1. The organic light emitting element L1 emits light according to the output current I_{OLED}. The driving transistor T2 includes a source electrode 57, a drain electrode 58, and a gate electrode 59, and the anode electrode 54 of the organic light emitting element L1 may be connected to the drain electrode 58 of the driving transistor T2. The configuration of the subpixels may be variably modified without being limited to the above-described example.

The front substrate 52 is assembled with the rear substrate 51 by a sealant while maintaining a certain gap therebetween to protect the driving circuit units and the organic light emitting elements formed on the rear substrate 51.

The flat display panel 50 is transferred to the flat display panel cutting apparatus 1 of the exemplary embodiment of the present invention in a state in which signal input/output units (not shown) of subpixels are exposed on a scrap portion 60 of the flat display panel 50, which is located at an outer edge of the rear substrate 51. That is, the flat display panel 50 is in a state of a base substrate.

The state of the base substrate refers to a phase of a fabrication process in which the organic light emitting elements L1 and the driving circuit units are formed between the rear substrate 51 and the front substrate 52 and characteristics of each subpixel are inspected, before being completed as a module.

Inspection of the pixel characteristics is completed in the state of the base substrate. After completing the inspection of the pixel characteristics, the flat display panel cutting apparatus 1 according to the exemplary embodiment of the present invention cuts the scrap portion 60 of the rear substrate 51 with the signal input/output units formed thereon out of the flat display panel 50 in the state of the base substrate.

Referring back to FIGS. 1 and 2, the flat display panel cutting apparatus I according to the exemplary embodiment of the present invention is configured to prevent the light emitting surface or the front substrate 52 from becoming defective or contaminated while cutting the flat display panel 50.

That is, when the flat display panel 50 is installed on the stage 10 of the flat display panel cutting apparatus 1, the non-light emitting surface comes in contact with the stage 10 while the light emitting surface is exposed upwardly.

For example, the rear substrate 51 of the OLED display is supported by the stage 10 while the front substrate 52 is exposed. The stage 10 may be fixedly installed or may be formed and installed to be raised or lowered.

The scribing support block 20 is installed to face an upper surface of the stage 10, and supports the light emitting surface of the flat display panel 50 while cutting the flat display panel 50. That is, the scribing support block 20 supports the front substrate 52 of the flat display panel 50.

While the stage 10 supports the overall weight of the flat display panel 50, the scribing support block 20 supports the front substrate 52 to in a manner that it resists an upward (z-axis direction) working force (operational force or interaction force) to the flat display panel 50 in the cutting operation by the cutter 30.

The scribing support block 20 is formed with a length corresponding to one side of the light emitting surface to support one side of the light emitting surface adjacent to a scribing line, and is disposed to correspond to the one side of the light emitting surface. In other words, the cribbing support block 20 is disposed to be aligned to one edge of the front substrate 52, and the length of the scribing support block 20, which is defined along a direction of the edge of the front substrate 52, is substantially the same as the length of the side of the front substrate 52.

That is, the scribing support block 20 is formed with a length corresponding to one side of the front substrate 52 along a scribing proceeding direction (y-axis direction) of the cutter 30 near the scribing line of the rear substrate 51, and is disposed to correspond to the one side of the front substrate 52.

Accordingly, when the rear substrate 51 is cut, the scribing support block 20 acts as a debris blocking wall for the front substrate 52, thus preventing the front substrate 52 from becoming contaminated by debris or foreign materials.

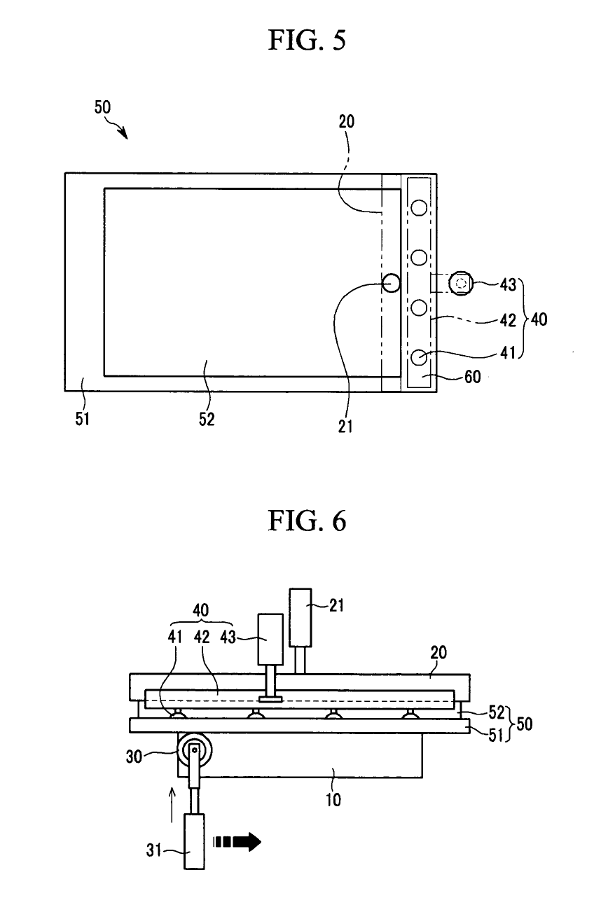

FIG. 5 is a top plan view of the flat display panel in FIG. 1 before it is scribed. With reference to FIG. 5, when the scribing support block 20 is formed to correspond to the length of one side of the front substrate 52, it forms the debris blocking wall in the overall range of one side of the front substrate 52.

In this point of view, the scribing support block 20 may be formed to be longer than the one side of the front substrate to effectively prevent the front substrate from becoming contaminated by debris (not shown).

The scribing support block 20 is connected with a first driving member 21. The first driving member 21 is installed to be perpendicular (y-axis direction) to the stage 10 and operates to raise or lower the scribing support block 20 to or from the front substrate 52. The first driving member 21 may employ an elastic means to drive the scribing support blocks.

The first driving member 21 is connected to the scribing support block 20 to enable the scribing support block 20 to apply a uniform working force in the overall range of one side of the front substrate 52. In the present exemplary embodiment, the first driving member 21 is connected to the center of the scribing support block 20.

FIG. 6 is a side view showing the flat display panel in FIG. 1 in a scribed state. With reference to FIG. 6, the cutter 30 is disposed at the side of a non-light emitting surface, and performs cutting the non-light emitting surface along a scribing line (y-axis direction) while receiving support resistance from the scribing support block 20 in order to cut the flat display panel 50.

The scribing support block 20 supports one side of the front substrate 52, and the cutter 30 scribes the rear substrate 51. Substantially, the scribing support block 20 supports the edge of one side of the front substrate 52, and the cutter 30 scribes the rear substrate 51 facing the edge of the one side of the front substrate 52.

For example, the cutter 30 may be a wheel. The wheel scribes the rear substrate 51 of the flat display panel along the lengthwise direction of the scribing support block 20, and specifically, along the edge of one side of the front substrate 52.

The cutter 30 is connected with a second driving member 31. The second driving member 31 is installed to be perpendicular (in the y-axis direction) to the rear substrate 51 of the flat display panel 50. The second driving member 31 may employ an elastic means to move the cutter 30 in the direction perpendicular to the rear substrate 51. The cutter 30 applies a scribing force to the rear substrate 51 or releases the scribing force from the rear substrate 51 according to the operation of the second driving member 31. The second driving member is mounted in a moving unit that operates to move the cutter 30 in the y-axis direction. The moving unit and mounting the second driving member in the moving unit can be easily implemented by a person in the art by employing a known art.

The scrap breaker 40 is configured to grip the scrap portion 60 that is to be separated from the flat display panel 50 after the cutting process.

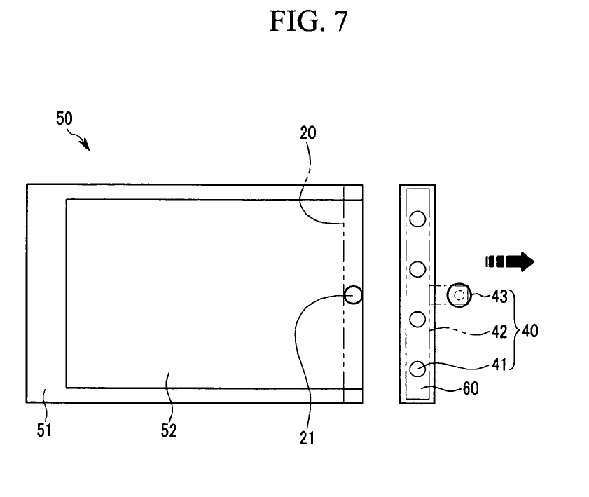

FIG. 7 is a top plan view of the flat display panel in FIG. 1 after cutting the scrap portion 60. With reference to FIG. 7, when the rear substrate 51 is cut, the scrap breaker 40 grips the scrap portion 60 cut and separated from the rear substrate 51.

The scrap breaker 40 includes cups 41 for vacuum-gripping the scrap portion 60, a delivery member 42 applying a vacuum to the cups 41, and a third driving member 43 connected with the delivery member 42.

One or more cups 41 may be formed along the lengthwise direction (in the y-axis direction) of the scrap portion 60. When a plurality of cups is formed, the cups are disposed at equal intervals at the delivery member 42 to apply uniform adsorptive force on the scrap portion 60. The delivery member 42 allows mounting of the cups 41 and applies uniform vacuum to each cup.

The third driving member 43 is connected with the delivery member 42 and operates to raise or lower the cups 41 in a vertical direction. The cups 41 may approach the scrap portion 60 of the rear substrate 51 according to the raising/lowering operation of the third driving member 43, and grip the scrap portion 60 by the vacuum applied on the scrap portion 60 from the cups 41. The third driving member 43 may employ an elastic means to move the cups 41.

After the scribing operation by the cutter 30, the third driving member 43 is raised in the z-axis direction, and accordingly, the scrap portion 60 is separated from the rear substrate 51. Because the scribing operation is performed while one side of the front substrate 52 is pressed by the scribing support block 20, and the scrap 60 is immediately separated and removed by using the scrap breaker 40, the front substrate 52 can be more effectively prevented from becoming defective and contaminated.

The third driving member is mounted in a moving unit, which is separately provided, to move the cups 41 in the x-axis direction. The moving unit and mounting the third driving member in the moving unit may be easily implemented by a person in the art by employing the known art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for cutting a flat display panel, comprising:
a stage for supporting a rear substrate of the flat display panel;
a scribing support block disposed over the flat display panel and supporting the flat display panel while the flat display panel is being cut;
a cutter to scribe the flat display panel; and
a scrap breaker to grip a scrap portion of the flat display panel that is to be separated from the flat display panel after cutting the flat display panel.

2. The apparatus of claim 1, wherein the scribing support block is disposed to be aligned to one edge of a front substrate of the flat display panel to support the front substrate.

3. The apparatus of claim 2, wherein the scribing support block has a length that is substantially the same as a length of the one edge of the front substrate of the flat display panel.

4. The apparatus of claim 3, wherein the scribing support block is connected to a first driving member that is disposed substantially perpendicular to the stage, the first driving member moving the scribing support block in a direction perpendicular to the front substrate.

5. The apparatus of claim 1, wherein the cutter includes a wheel, the cutter scribing the rear substrate of the flat display panel in a direction along an edge of the scribing support block.

6. The apparatus of claim 5, wherein the wheel is connected to a second driving member that moves the wheel in a direction perpendicular to the rear substrate.

7. The apparatus of claim 1, wherein the scrap breaker comprises:
a cup to vacuum-grip the scrap portion of the flat display panel;
a delivery member holding the cup and applying a vacuum to the cup; and
a third driving member connected with the delivery member to move the delivery member and the cup in a direction perpendicular to the rear substrate.

8. The apparatus of claim 1, wherein the flat display panel is formed as an organic light emitting diode (OLED) display.

9. The apparatus of claim 1, wherein the front substrate of the flat display panel includes a light emitting surface of the flat display panel.

10. An apparatus for cutting a flat display panel, comprising:
a stage to support a rear substrate of an organic light emitting diode (OLED) display;
a scribing support block to support a front substrate of the OLED display;
a cutter to scribe the rear substrate of the OLED display; and
a scrap breaker to grip a scrap portion of the OLED display that is to be separated from the rear substrate after cutting the OLED display.

11. The apparatus of claim 10, wherein the scribing support block is disposed to be aligned to one edge of a front substrate, and the scribing support block has a length that is substantially the same as a length of the one edge of the front substrate of the OLED display.
